(19) United States
(12) Patent Application Publication
(10) Pub. No.: US 2025/0216613 A1
(43) Pub. Date: Jul. 3, 2025

(54) HIGH EFFICIENCY POLARIZATION-DIVERSITY TWO-DIMENSIONAL WAVEGUIDE GRATING COUPLER

(71) Applicant: The Chinese University of Hong Kong, Hong Kong (CN)

(72) Inventors: Hon Ki TSANG, Hong Kong (CN); Xuetong ZHOU, Hong Kong (CN)

(21) Appl. No.: 19/004,785

(22) Filed: Dec. 30, 2024

Related U.S. Application Data
(60) Provisional application No. 63/615,856, filed on Dec. 29, 2023.

(51) Int. Cl. G02B 6/34; G02B 6/30

(52) U.S. Cl. CPC G02B 6/34; G02B 6/30

(57) ABSTRACT

A waveguide grating coupler (WGC) for coupling light transmitted between an integrated optical waveguide and an optical fiber and a method for making the waveguide grating coupler are provided. The waveguide grating coupler working for dual polarization includes a grating layer having a first plurality of etched holes and an overlay layer disposed on the grating layer, having a second plurality of etched holes. At least one of the second plurality of etched holes partially overlaps a corresponding etched hole of the first plurality of etched holes. The overlay layer is configured to create a shift of every period of grating to the grating layer to achieve upwards constructive interference and downwards destructive interference of light such that coupling efficiencies of both vertical grating coupling and angle coupled grating coupling are enhanced for a single mode optical fiber, a few mode optical fiber, or a multi-mode optical fiber.

### CROSS-REFERENCE TO RELATED APPLICATION

This application claims the benefit of U.S. Provisional Application Ser. No. 63/615,856, filed Dec. 29, 2023, which is hereby incorporated by reference in its entirety including any tables, figures, or drawings.

### BACKGROUND OF THE INVENTION

Polarization division multiplexing (PDM) communications leverage two orthogonal polarizations to double transmission capacity and enhance spectral efficiency. The coupling of these orthogonal polarizations from optical fibers to photonic integrated circuits is therefore imperative. Two-dimensional waveguide grating couplers (WGC) serve this purpose by coupling orthogonal modes from the fiber to a single polarization in two silicon waveguides. However, devices produced through deep UV photolithography in commercial foundries still exhibit suboptimal performance. Although reported results can achieve a 3.2 dB coupling loss, they necessitate a minimum feature size of 80 nm using a silicon wafer having a nonstandard thickness of 310 nm [1]. With a standard silicon wafer having a thickness of 220 nm and a minimum feature size above 180 nm, the best reported coupling loss result is only approximately 6 dB [2].

To avoid the second-order Bragg back reflection of the grating coupler, off-vertical coupling is commonly employed. The most successful reported off-vertical polarization diversity two-dimensional WGC achieves a −1.8 dB coupling efficiency (CE) but requires additional bottom metal reflectors and benzocyclobutene bonding technology [3]. Nonetheless, this device still exhibits a high polarization-dependent loss (PDL) of over 1 dB. Various attempts have been made to mitigate the substantial PDL introduced by off-vertical coupling, including the use of specially designed etched shapes [4] or active phase control [5].

An alternative approach for reducing PDL is to employ WGC coupled to perfectly vertical optical fibers. The most successful polarization diversity two-dimensional WGC previously reported achieved a 2.6 dB coupling loss using fine nanostructures as small as 40 nm, defined by electron-beam lithography (EBL) [6]. However, this approach introduced a high PDL of 3 dB. The best efficiency reported for a perfectly vertical, polarization-independent grating coupler is-2.5 dB with four-port coupling [7], utilizing a silicon layer having a thickness of 340 nm and feature sizes down to 123 nm.

Addressing the challenge of high-efficiency and low PDL polarization diversity WGC, especially for mass production employing deep UV photolithography, remains an ongoing concern crucial for cost-effective fabrication of high-performance polarization division multiplexing transceivers.

### BRIEF SUMMARY OF THE INVENTION

There continues to be a need in the art for improved designs and techniques for high efficiency polarization-diversity two-dimensional waveguide grating couplers.

According to an embodiment of the subject invention, a waveguide grating coupler (WGC) for coupling light transmitted between an integrated optical waveguide and an optical fiber is provided. The waveguide grating coupler comprises a grating layer comprising a first plurality of etched holes; and an overlay layer disposed on the grating layer, comprising a second plurality of etched holes, wherein at least one of the second plurality of etched holes partially overlaps a corresponding etched hole of the first plurality of etched holes; and wherein the overlay layer is configured to create a shift of every period of grating to the grating layer to achieve upwards constructive interference and downwards destructive interference of light such that coupling efficiencies of both vertical grating coupling and angle coupled grating coupling are enhanced for a single mode optical fiber, a few mode optical fiber, or a multi-mode optical fiber. Moreover, the overlay layer has a thickness of 160 nm and is fully etched, while the grating layer has a thickness of 220 nm and is 70 nm shallowly etched. A diameter of the first plurality of etched holes of the grating layer is about 292 nm, while a diameter of the etched holes of the second plurality of overlay layer is about 315 nm. The multi-mode optical fiber is an OM2 optical fiber, an OM3 optical fiber, an OM4 optical fiber, or an OM5 optical fiber. Furthermore, the WGC has a coupling efficiency of about-2.61 dB. The WGC may additionally comprise a first plurality of reflectors disposed adjacent to two lateral surfaces of the grating layer and a second plurality of reflectors disposed adjacent to two lateral surfaces of the overlay layer.

According to certain embodiment of the subject invention, a system for optical communication is provided, comprising an integrated optical waveguide; an optical fiber; and the waveguide grating coupler (WGC) described above configured for coupling light transmitted between an integrated optical waveguide and an optical fiber. The coupling may be either vertical coupling or off-vertical coupling.

According to another embodiment of the subject invention, a method for making a waveguide grating coupler (WGC) for coupling light transmitted between an integrated optical waveguide and optical fibers is provided. The method comprises providing a grating layer comprising a first plurality of etched holes; providing an overlay layer disposed on the grating layer and comprising a second plurality of etched holes; and optimizing structural parameters of the grating layer and the overlay layer based on a numerical method to obtain a high coupling efficiency. The optimizing structural parameters of the grating layer and the overlay layer includes optimizing a diameter of the first plurality of etched holes of the grating layer and/or a diameter of the second plurality of etched holes of the overlay layer. The optimizing structural parameters of the grating layer and an overlay layer includes optimizing shift and/or a width of each period in the overlay layer and/or the grating layer to realize graded increase effective index of an external vertical subwavelength structure to obtain a blazed structure of grating. The numerical method is a genetic algorithm (GA) method or a particle swarm optimization method. The overlay layer has a thickness of 160 nm and is fully etched. The grating layer has a thickness of 220 nm and is 70 nm shallowly etched. A diameter of the first plurality of etched holes of the grating layer is about 292 nm, while a diameter of the second plurality of etched holes of the overlay layer is about 315 nm. The WGC has a coupling efficiency of about-2.61 dB.

### BRIEF DESCRIPTION OF THE DRAWINGS

FIG. 1A is a schematic diagram showing cross-sections of a lower-level silicon layer, FIG. 1B is a schematic diagram showing an upper-level polysilicon layer, and FIG. 1C is a schematic diagram showing cross sections and the structure of the two-dimensional perfectly vertical coupled dual polarization grating coupler, according to an embodiment of the subject invention.

FIG. 2A is a plot diagram showing the relationship between the structure width and the grating period number of the lower-level silicon layer and FIG. 2B is a plot diagram showing the relationship between the structure width and the grating period number of the upper-level polysilicon layer, according to an embodiment of the subject invention.

FIG. 3 shows three-dimensional (3D) simulation results of the relationship between the wavelength and the coupling efficiency of the grating coupler of the subject invention, according to an embodiment of the subject invention.

### DETAILED DISCLOSURE OF THE INVENTION

Embodiments of the subject invention pertain to a waveguide grating coupler (WGC) for coupling light transmitted between an integrated optical waveguide and an optical fiber.

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention pertains. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

When the term “about” is used herein, in conjunction with a numerical value, it is understood that the value can be in a range of 90% of the value to 110% of the value, i.e. the value can be +/−10% of the stated value. For example, “about 1 kg” means from 0.90 kg to 1.1 kg.

In describing the invention, it will be understood that a number of techniques and steps are disclosed. Each of these has individual benefits and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

Photonic integrated circuits have found extensive deployment in optical fiber-based interconnects within hyperscale data centers. The increasing demand for enhanced performance has given rise to the need for high-efficiency dual-polarization grating couplers. These couplers play an important role in achieving lower power consumption, cost reduction, and expanded transmission capacity, especially for polarization multiplexing transceivers.

According to the embodiments of the subject invention, a high-performance dual port and dual polarization waveguide grating coupler (WGC) is provided. The WGC can be fabricated by deep UV photolithography for perfectly vertical coupling to standard single mode fiber to achieve high efficiency and low polarization dependent loss.

In particular, the waveguide grating coupler is designed to couple light transmitted between an integrated optical waveguide and optical fibers including single mode, few-mode, and multimode fiber (for example, OM2, OM3, OM4, or OM5) with high coupling efficiency for dual polarization. The structure may be used for either perfectly vertical coupling or off-vertical coupling from a horizontal chip surface. The fabrication of the waveguide grating coupler can be accomplished by, for example, commercial silicon photonic foundries using 193 nm deep-ultraviolet lithography with a minimum feature size greater than 171 nm.

Moreover, according to the embodiments of the subject invention, a method for designing high efficiency grating couplers for dual polarization is provided. In the method, an optimized polysilicon overlay pattern is combined with a two-dimensional silicon grating layer. Unlike the conventional methods, the embodiments of the subject invention exhibit the remarkable capability to significantly enhance the coupling efficiency of single-mode dual-polarization waveguide grating couplers.

In practice, the improvement elevates the optical coupling efficiency from approximately −6 dB, as observed when utilizing traditional grating couplers fabricated by commercial foundries, to a more favorable-2.61 dB. Furthermore, the waveguide grating coupler of the subject invention that incorporates a perfectly vertical coupling mechanism can achieve a theoretical polarization-dependent loss of zero.

In one embodiment, a method for making a two-dimensional WGC with perfectly vertical polarization diversity is provided. The optimized shift pattern overlay method demonstrates high Coupling Efficiency (CE) in perfectly vertically coupled WGC. For instance, the embodiments of the subject invention can achieve a theoretically zero PDL and a minimal coupling loss of −2.61 dB. With a minimum feature size of 171 nm, this method enables fabrication based on deep ultraviolet photolithography in an open-access multi-project wafer (MPW) foundry.

In one embodiment, the high-efficiency dual-polarization optical interface can be configured to connect photonic integrated circuits to optical fibers of single mode, few mode, or multimode (for example, OM2, OM3, OM4, or OM5).

### Design and Optimization of Grating Coupler

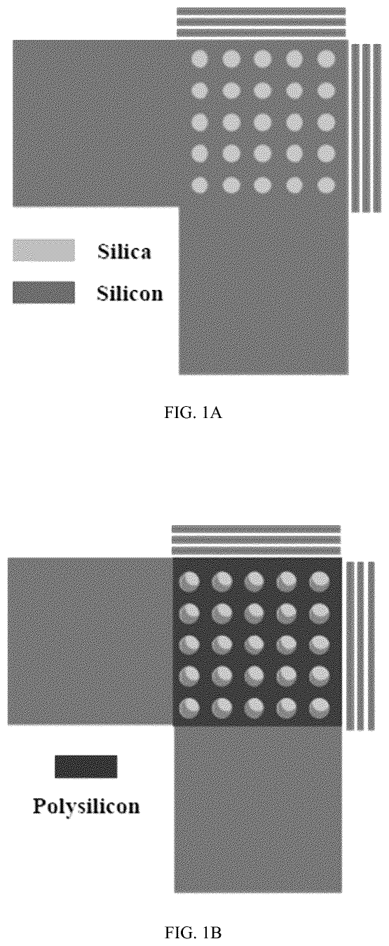

Referring to FIGS. 1A-1C, the method of optimized shift pattern polysilicon overlay for achieving high CE and perfectly vertical coupling according to the embodiments of the subject invention is integrated with the traditional method for implementing polarization diversity two-dimensional WGC, resulting in dual polarization WGC with low PDL high-performance and high efficiency.

In one embodiment, the dual polarization coupling is configured from the integrated chip to out-of-plane coupling into the fiber, achieving a 90-degree change in the direction of light propagation.

In one embodiment, the genetic algorithm (GA) is utilized to improve the performance of the dual polarization grating coupler to obtain high CE. The minimum feature size of the grating is limited to a size greater than 171 nm during the optimization as required by the design rule in the foundry. A Silicon On Insulator (SOI) wafer is used with a silicon layer having a thickness of about 220 nm and a buried-oxide layer having a thickness of about 2 μm. The lower-level silicon layer having a thickness of 220 nm is 70 nm shallowly etched, while the upper-level polysilicon overlay layer having a thickness of 160 nm is fully etched.

In one embodiment, the polysilicon overlay is disposed only on the grating part.

In one embodiment, both the lower silicon layer and the upper polysilicon layer are etched.

The dual polarization grating coupler of the subject invention can be fabricated by volume production through the standard fabrication process of deep UV photolithography developed in the last decade by a commercial foundry (IMEC).

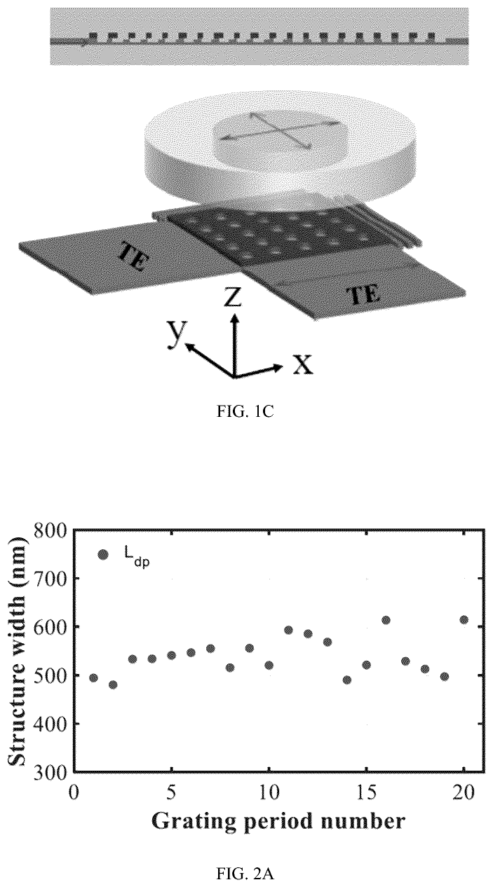

FIGS. 1A-1C show the structure of the grating coupler for the dual polarization. Further, FIGS. 2A-2B show parameters of the lower-level grating layer and the upper-level overlay layer for the dual polarization grating coupler after GA optimization. In particular, FIG. 2A shows the relationship between the structure width and the grating period number of the lower-level grating layer and FIG. 2B shows the relationship between the structure width and the grating period number of the upper-level layer. Ldp and Lup denote the width of the periods in the lower 70 nm shallow etched grating layer and upper 160 nm overlay layer, respectively. The diameter of the plurality of etched holes in the lower-level grating layer is preferably about 292 nm, while the diameter of the plurality of etched holes in the upper-level overlay layer is preferably about 315 nm. Performance may be further improved if finer feature sizes are adopted. Three rectangular slabs are used as end reflectors, each having a width of 184 nm and being spaced apart by a distance of 181 nm.

Preferably, the plurality of etched holes are formed to have a circular shape and large feature sizes to fabricate volume production by photolithography. Moreover, the hole size is kept uniform for both the lower silicon layer and upper polysilicon layer. The diameter of the etched hole may be as large as 300 nm to be easily fabricated by photolithography for volume production.

Preferably, the etched regions comprise holes. However, in some cases, the pattern can be reversed, with the remaining etched regions forming pillars. This configuration can be applied to the lower silicon layer, the upper polysilicon layer, or a combination of both. For example, the lower silicon layer may have etched holes, while the remaining regions in the upper polysilicon layer form pillars. Alternatively, other combinations, such as etched holes in the upper polysilicon layer and pillars in the lower silicon layer, or vice versa, are possible. In some cases, the remaining etched regions in both the lower and upper layers may form pillars.

Preferably, there is no gap between the upper polysilicon layer and the lower silicon layer. However, in some cases, there may be some slot materials between the lower silicon layer and the upper polysilicon layer, including silica, silicon nitride but not limit to these materials.

Preferably, the upper polysilicon layer etched region or etched left region has some shift. However, in some cases, there may be no shift between the upper polysilicon layer etched region and etched left region.

Preferably, uniform etched hole (or uniform etched left pillar) is used with varied grating periods to realize grating apodization. However, in some cases, nonuniform etched hole (or nonuniform etched left pillar) can be used to realize grating apodization, and circular hole or pillar is used here for easy fabrication. Moreover, in some cases, the etched region or etched left region can be other shapes.

Preferably, the lower-level grating layer is made of silicon. Alternatively, the lower-level grating layer may be made of any suitable material including, but not limited to, lithium niobate or silicon nitride.

Preferably, the waveguide is disposed to be perfectly orthogonal to the grating layer, allowing zero polarization dependent loss.

Preferably, a chirped design is provided for perfectly vertical coupling (0=0) with zero polarization dependent loss. Furthermore, the phase offset between the polysilicon layer and lower silicon layer is configured for grating apodization to realize high coupling efficiency for both polarizations.

Preferably, the phase shift between the polysilicon upper grating and underlying grating layer is configured for apodization to realize high coupling efficiency for both polarizations, while keeping large feature sizes to facilitate volume production.

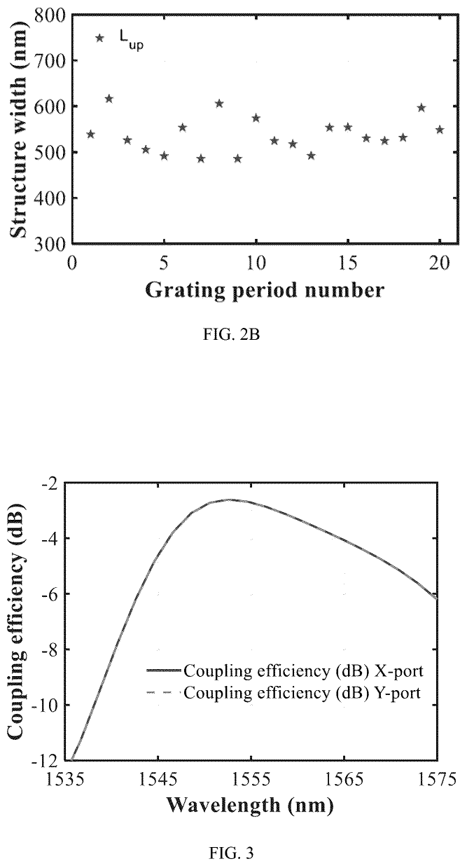

Preferably, the upper-level overlay layer is made of polysilicon. Alternatively, the upper-level overlay layer may be made of any suitable material including, but not limited to, lithium niobate or silicon nitride or any other suitable dielectric material. FIG. 3 shows the results of 3D Finite-Difference Time-Domain (FDTD) simulation of the dual polarization grating coupler according to the embodiments of the subject invention. The simulation results demonstrate that coupling efficiency of −2.61 dB can be obtained for the orthogonal polarizations at a frequency of 1552.6 nm with 3 dB bandwidth of 30 nm from a frequency range of 1543 nm to 1573 nm. The symmetry and normal orientation of the fiber relative to the grating surface result in theoretically identical CE for the X and Y polarization in the fiber, as is confirmed by the 3D FDTD simulation results of FIG. 3 which shows identical CEs for the X-port and Y-port inputs.

The waveguide grating coupler of the subject invention can be fabricated by deep UV photolithography in volume production. Previous experiment results of high efficiency grating couplers fabricated at IMEC matches well with the 3D FDTD simulations [8, 12].

Methods to improve the coupling efficiency of the waveguide grating couplers include using minimum feature size of 80 nm and a nonstandard wafer such as a silicon wafer having a thickness of 310 nm [1], using bottom metal reflector and benzocyclobutene bonding technology [2], using special designed etched shapes [3], or active phase control have been tried to reduce the polarization dependent loss [4], using fine nanostructures, as small as 40 nm [5] defined by electro-beam lithography (EBL), using perfectly vertical polarization-independent grating coupler with four port coupling [6] based on a layer such as a silicon layer having a thickness of 340 nm and feature sizes down to 123 nm.

The embodiments of the subject invention are based on the optimized pattern of the overlay deposited over the grating structure. By selectively optimizing diameters of the etched holes and widths of periods in the overlay layer and the lower-level grating layer, upwards light constructive interference and downwards light destructive interference of the grating coupler can be achieved. Consequently, the directionality of the grating coupler is improved.

Moreover, the shift between the upper-level overlay layer and the lower-level grating layer is not confined by the minimum feature size limitations imposed by the 193 nm deep-ultraviolet lithography. Instead, it is restricted by the accuracy of photolithography registration. Introducing a shift of the overlay layer with respect to the grating gradually increases the effective index of the subwavelength structure in the vertical direction. Through careful design, the blazing of the diffraction grating can be effectively realized, thereby enhancing the coupling efficiency.

To obtain high coupling efficiency through the approach outlined above, an additional step of numerical optimization of the periods and etched hole diameter and shift of the overlay layer to the lower-level grating layer needs to be carried out in order to engineer the diffracted mode to match the mode profile of the optical fiber.

The optimization may be carried out using a subwavelength structure with minimum feature size greater than 171 nm to satisfy the design rules for fabrication at a commercial foundry. The simulation may use a symmetric structure combined with the above optimized shift pattern overlay and optimization method to realize a perfectly vertical coupled high efficiency two-dimensional dual polarization grating coupler.

The results show that the method according to the embodiments of the subject invention can achieve a high coupling efficiency of −2.61 dB for perfectly vertical coupling without polarization dependent loss in theory. Moreover, the method enables high coupling efficiency for dual polarization while minimizing polarization-dependent loss under the constrain of 193 nm deep-ultraviolet lithography.

In one embodiment, a method is presented for making polarization diversity two-dimensional WGC, designed to couple the orthogonal modes of a perfectly vertically orientated standard single mode fiber to the Transverse Electric (TE) polarization in two orthogonal silicon waveguides. The WGC demonstrates a CE of −2.61 dB and theoretically identical CE for the orthogonal polarizations in the fiber. Notably, the grating coupler of the subject invention can be fabricated in volume production using standard fabrication process in the commercial foundry. The grating coupler exhibits great potential for integration with the multicore fiber and in polarization-division multiplexing networks. Therefore, the grating coupler can play a crucial role in future high-capacity polarization division multiplexing or space division multiplexing communication networks.

The predominant application of the embodiments of the subject invention is anticipated in forthcoming data centers, where the existing power consumption levels may be inadequate for meeting the demands of advanced high-capacity optical communication systems-especially in hyperscale data centers. A crucial aspect in maintaining adherence to the power budget is the implementation of an efficient coupling strategy for polarization multiplexing.

As the demand for efficiently coupling light with dual polarization grows in the field of optical communication systems, the WGC device of the subject invention is poised to meet the market's need for enhanced capacity through dual polarization.

In one embodiment, a waveguide grating coupler (WGC) for coupling light transmitted between an integrated optical waveguide and an optical fiber comprises a grating layer comprising a first plurality of etched holes; and an overlay layer disposed on the grating layer, comprising a second plurality of etched holes; wherein at least one of the second plurality of etched holes partially overlaps a corresponding etched hole of the first plurality of etched holes; and wherein the overlay layer is configured to create a shift of every period of grating to the grating layer to achieve upwards constructive interference and downwards destructive interference of light such that coupling efficiencies of both vertical grating coupling and angle coupled grating coupling are enhanced for a single mode optical fiber, a few mode optical fiber, or a multi-mode optical fiber.

In one embodiment, the overlay layer has a thickness of 160 nm and is fully etched. In one embodiment, the grating layer has a thickness of 220 nm and is 70 nm shallowly etched.

In one embodiment, a diameter of the first plurality of etched holes of the grating layer is about 292 nm.

In one embodiment, a diameter of the etched holes of the second plurality of overlay layer is about 315 nm.

In one embodiment, the multi-mode optical fiber is an OM2 optical fiber, an OM3 optical fiber, an OM4 optical fiber, or an OM5 optical fiber.

In one embodiment, the WGC has a coupling efficiency of about-2.61 dB.

In one embodiment, for dual polarization coupling, a coupling efficiency of −2.61 dB (55%) is achieved for both TE and TM mode.

In one embodiment, the WGC further comprises a first plurality of reflectors disposed adjacent to two lateral surfaces of the grating layer and a second plurality of reflectors disposed adjacent to two lateral surfaces of the overlay layer.

In one embodiment, a method for making a waveguide grating coupler (WGC) for coupling light transmitted between an integrated optical waveguide and optical fibers comprises providing a grating layer comprising a first plurality of etched holes; providing an overlay layer disposed on the grating layer and comprising a second plurality of etched holes; and optimizing structural parameters of the grating layer and the overlay layer based on a numerical method to obtain a high coupling efficiency.

In one embodiment, the optimizing structural parameters of the grating layer and the overlay layer includes optimizing a diameter of the first plurality of etched holes of the grating layer and/or a diameter of the second plurality of etched holes of the overlay layer.

In one embodiment, the optimizing structural parameters of the grating layer and an overlay layer includes optimizing shift and/or a width of each period in the overlay layer and/or the grating layer to realize graded increase effective index of an external vertical subwavelength structure to obtain a blazed structure of grating.

In one embodiment, the numerical method is a genetic algorithm (GA) method.

In one embodiment, the numerical method is a particle swarm optimization method.

In one embodiment, the numerical method is an adjoint optimization method.

In one embodiment, the numerical method is a gradient descent optimization method.

In one embodiment, the numerical method is a deep neural network method.

In one embodiment, the overlay layer has a thickness of 160 nm and is fully etched.

In one embodiment, the grating layer has a thickness of 220 nm and is 70 nm shallowly etched.

In one embodiment, a diameter of the first plurality of etched holes of the grating layer is about 292 nm.

In one embodiment, a diameter of the second plurality of etched holes of the overlay layer is about 315 nm.

In one embodiment, the WGC has a coupling efficiency of about-2.61 dB.

In one embodiment, a system for optical communication comprises an integrated optical waveguide; an optical fiber; and the waveguide grating coupler (WGC) of claim 1, configured for coupling light transmitted between an integrated optical waveguide and an optical fiber.

In one embodiment, the coupling is vertical coupling or off-vertical coupling.

The embodiments of the subject invention are designed to be compatible with polarization division multiplexing. Hence, the high-performance waveguide grating coupler can be used in high-capacity silicon photonic transceivers and is suitable for polarization division multiplexing.

The approach comprises a structure in waveguide grating couplers used with a method to optimize the coupling efficiency under the constrain rule of 193 nm deep-ultraviolet lithography for dual polarization, thereby achieving high coupling efficiency for dual polarization while satisfying the minimum feature size constraint of 170 nm.

Accordingly, the subject invention paves the way for the development of optical transceivers capable of transmitting terabit/s data. Achieved through the strategic utilization of dual polarization, coupled with the incorporation of multiple wavelength channels or spatial mode channels, this advancement is characterized by its ability to maintain significantly lower power consumption levels.

All patents, patent applications, provisional applications, and publications referred to or cited herein are incorporated by reference in their entirety, including all figures and tables, to the extent they are not inconsistent with the explicit teachings of this specification.

It should be understood that the examples and embodiments described herein are for illustrative purposes only and that various modifications or changes in light thereof will be suggested to persons skilled in the art and are to be included within the spirit and purview of this application and the scope of the appended claims. In addition, any elements or limitations of any invention or embodiment thereof disclosed herein can be combined with any and/or all other elements or limitations (individually or in any combination) or any other invention or embodiment thereof disclosed herein, and all such combinations are contemplated with the scope of the invention without limitation thereto.

### REFERENCES

[1] F. Boeuf et al., “A multi-wavelength 3D-compatible silicon photonics platform on 300 mm SOI wafers for 25 Gb/s applications,” in 2013 IEEE International Electron Devices Meeting, 9-11 Dec. 2013 2013, pp. 13.3.1-13.3.4, doi: 10.1109/IEDM.2013.6724623.
[2] D. Yi, X. Wu, and H. K. Tsang, “Ultra-Compact Polarization Analyzer Based on Micro-Ring Resonators,” IEEE Photonics Technol. Lett., vol. 33, no. 24, pp. 1371-1374, 2021.
[3] Y. Luo et al., “Low-loss two-dimensional silicon photonic grating coupler with a backside metal mirror,” Opt. Lett., vol. 43, no. 3, pp. 474-477, Feb. 1, 2018.
[4] J. Zou, Y. Yu, and X. Zhang, “Two-dimensional grating coupler with a low polarization dependent loss of 0.25 dB covering the C-band,” Opt. Lett., vol. 41, no. 18, pp. 4206-9, Sep. 15, 2016.
[5] R. Halir, D. Vermeulen, and G. Roelkens, “Reducing Polarization-Dependent Loss of Silicon-on-Insulator Fiber to Chip Grating Couplers,” IEEE Photonics Technol. Lett., vol. 22, no. 6, pp. 389-391, 2010.
[6] T. Watanabe, Y. Fedoryshyn, and J. Leuthold, “2-D Grating Couplers for Vertical Fiber Coupling in Two Polarizations,” IEEE Photonics J., vol. 11, no. 4, pp. 1-9, 2019.
[7] Z. Y. Zhang et al., “Two-Dimensional Apodized Grating Coupler for Polarization-Independent and Surface-Normal Optical Coupling,” (in English), J. Lightwave Technol., vol. 38, no. 15, pp. 4037-4044 Aug. 1, 2020.
[8] X. Zhou and H. K. Tsang, “High Efficiency Multimode Waveguide Grating Coupler for Few-Mode Fibers,” IEEE Photonics J., vol. 14, no. 4, pp. 1-5, August 2022.
[9] X. Zhou and H. K. Tsang, “Optimized shift-pattern overlay for high coupling efficiency waveguide grating couplers,” Opt. Lett., vol. 47, no. 15, pp. 3968-3971 August 2022.
[10] W. Bogaerts, D. Taillaert, P. Dumon, D. Van Thourhout, R. Baets, and E. Pluk, “A polarization-diversity wavelength duplexer circuit in silicon-on-insulator photonic wires,” Opt. Express, vol. 15, no. 4, pp. 1567-78, Feb. 19, 2007.
[11] X. Zhou and H. K. Tsang, “Photolithography Fabricated Sub-decibel High-efficiency Silicon Waveguide Grating Coupler,” IEEE Photonics Technol. Lett., vol. 35, no. 1, pp. 43-46, 2022.
[12] X. Zhou. G. Hu. Y. Qin. and H. Tsang. “Polarization-independent Waveguide Grating Couplers by using an Optimized Polysilicon Overlay.” Olpt. Lett., vol. 47, no. 22. pp. 5825-5828, 2022.

We claim:

1. A waveguide grating coupler (WGC) for coupling light transmitted between an integrated optical waveguide and an optical fiber, comprising:
a grating layer comprising a first plurality of etched holes; and
an overlay layer disposed on the grating layer, comprising a second plurality of etched holes;
wherein at least one of the second plurality of etched holes partially overlaps a corresponding etched hole of the first plurality of etched holes; and
wherein the overlay layer is configured to create a shift of every period of grating to the grating layer to achieve upwards constructive interference and downwards destructive interference of light such that coupling efficiencies of both vertical grating coupling and angle coupled grating coupling are enhanced for a single mode optical fiber, a few mode optical fiber, or a multi-mode optical fiber.

2. The WGC of claim 1, wherein the overlay layer has a thickness of 160 nm and is fully etched.

3. The WGC of claim 1, wherein the grating layer has a thickness of 220 nm and is 70 nm shallowly etched.

4. The WGC of claim 1, wherein a diameter of the first plurality of etched holes of the grating layer is about 292 nm.

5. The WGC of claim 1, wherein a diameter of the second plurality of etched holes of the overlay layer is about 315 nm.

6. The WGC of claim 1, wherein the multi-mode optical fiber is an OM2 optical fiber, an OM3 optical fiber, an OM4 optical fiber, or an OM5 optical fiber.

7. The WGC of claim 1, wherein the grating layer is made of silicon, lithium niobate, or silicon nitride.

8. The WGC of claim 1, wherein the overlay layer is made of polysilicon, lithium niobate, or silicon nitride.

9. A method for making a waveguide grating coupler (WGC) for coupling light transmitted between an integrated optical waveguide and optical fibers, comprising:
providing a grating layer comprising a first plurality of etched holes;
providing an overlay layer disposed on the grating layer and comprising a second plurality of etched holes; and
optimizing structural parameters of the grating layer and the overlay layer based on a numerical method to obtain a high coupling efficiency.

10. The method of claim 9, wherein the optimizing structural parameters of the grating layer and the overlay layer includes optimizing a diameter of the first plurality of etched holes of the grating layer and/or a diameter of the second plurality of etched holes of the overlay layer.

11. The method of claim 9, wherein the optimizing structural parameters of the grating layer and the overlay layer includes optimizing shift and/or a width of each period in the overlay layer and/or the grating layer to realize graded increase effective index of an external vertical subwavelength structure to obtain a blazed structure of grating.

12. The method of claim 9, wherein the numerical method is a genetic algorithm (GA) method.

13. The method of claim 9, wherein the numerical method is one of a particle swarm optimization method, an adjoint optimization method, a gradient descent optimization method, or a deep neural network method.

14. The method of claim 9, wherein the overlay layer has a thickness of 160 nm and is fully etched.

15. The method of claim 9, wherein the grating layer has a thickness of 220 nm and is 70 nm shallowly etched.

16. The method of claim 9, wherein a diameter of the first plurality of etched holes of the grating layer is about 292 nm.

17. The method of claim 9, wherein a diameter of the second plurality of etched holes of the overlay layer is about 315 nm.

18. The method of claim 9, wherein the grating layer is made of silicon, lithium niobate, or silicon nitride.

19. A system for optical communication, comprising:
an integrated optical waveguide;
an optical fiber; and
the waveguide grating coupler (WGC) of claim 1, configured for coupling light transmitted between an integrated optical waveguide and an optical fiber.

20. The system of claim 19, wherein the coupling is vertical coupling or off-vertical coupling.
